(19) United States
(12) Patent Application Publication
(10) Pub. No.: US 2009/0206076 A1
(43) Pub. Date: Aug. 20, 2009

(54) COOKING DEVICE

(76) Inventors: Seiichi Hirano, Osaka (JP); Seiji Kanbara, Nishinomiya (JP); Kenji Kimura, Osaka (JP); Tatsuhiko Nakamura, Osaka (JP)

Correspondence Address: BIRCH STEWART KOLASCH & BIRCH, PO BOX 747, FALLS CHURCH, VA, 22040-0747, US

(21) Appl. No.: 12/370,673

(22) Filed: Feb. 13, 2009

(30) Foreign Application Priority Data
Feb. 15, 2008 (JP) 2008-035074

(51) Int. Cl. H05B 6/64; H05B 1/00; F27D 11/00

(52) U.S. Cl. 219/756; 219/209; 219/438; 219/201

(57) ABSTRACT

A cooking device comprises: a first electromagnetic generating unit and a second electromagnetic generating unit for generating electromagnetic waves to cook; a heating chamber that introduces electromagnetic waves generated by each of the electromagnetic generating units to heat an object; and fans for cooling each of the electromagnetic generating units, wherein the first electromagnetic generating unit is arranged in an upper position and the second electromagnetic generating unit is arranged in a lower position, a first blowing path and a second blowing path are arranged to guide air blown out by the fans to the peripheries of the respective electromagnetic generating units, and two of the electromagnetic generating units are cooled in the same condition.

This Non-provisional application claims priority under 35 U.S.C. §119(a) on Patent Application No. 2008-035074 filed in Japan on Feb. 15, 2008, the entire contents of which are hereby incorporated by reference.

### BACKGROUND OF THE INVENTION

1. Field of the Invention

The present invention relates to a cooking device that heats an object, such as a microwave oven.

2. Description of Related Art

Japanese Patent Application Laid-Open No. 5-322187 shows a cooking device including: a heating chamber for heating an object; a magnetron for generating a microwave; a wave guide for guiding the microwave generated by the magnetron to the heating chamber; and a fan for cooling the magnetron.

A cooking device for domestic use is known to be arranged in a household kitchen and to be used by household members. In addition, a cooking device for a business use is known to be arranged in a kitchen of hotel, restaurant, fast food shop, or the like, and to be used by kitchen staffs or the like for serving a dish or food to a customer. The business-use cooking device requires relatively large calorific power to heat an object within short-time, because the device is frequently used during opening time for business in order to respond immediately to customer demands. As opposed to the business-use cooking device, the domestic-use cooking device does not require such a relatively large calorific power to heat an object, because the device is used only a several times a day.

Accordingly, the domestic-use cooking device provides one magnetron, and is configured to emit microwave generated by the magnetron to the heating chamber, with propagation of the microwave through one wave guide. On the other hand, the business-use cooking device provides: one pair of magnetrons that are laterally spaced apart each other and arranged in parallel on one side of an upper portion of a heating chamber; two wave guides that are arranged on upper sides of the respective magnetrons; two fans that are arranged on lower sides of the respective magnetrons; and two blowing paths that guide air, which is flown by the respective fans, around the respective magnetrons. Further, the business-use cooking device is configured to emit microwave generated by the pair of magnetrons to the heating chamber, with propagation of the microwave through two wave guides (e.g. Japanese Patent Application Laid-Open No. 5-322187).

### SUMMARY OF THE INVENTION

However, in a cooking device providing the one pair of magnetrons that are laterally spaced apart and arranged in parallel on one side of an upper portion of a heating chamber as shown in Japanese Patent Application Laid-Open No. 5-322187, a position for the parallel arrangement of the one pair of magnetrons is limited by a volume of the heating chamber which may cause a relatively short distance between the two magnetrons. If microwave generating sections in the two magnetrons are laterally opposed to each other in a relatively short distance, a heat of air that has cooled one of the two magnetrons may significantly affect the other of the two magnetrons. Therefore, there is concern that a cooling effect for one of the two magnetrons is significantly different from a cooling effect for the other of the two magnetrons. In such a case, the magnetron that has a smaller cooling effect is prone to failure earlier than the other magnetron that has a larger cooling effect.

When one of the two magnetrons is broken, the cooking device having the two magnetrons cannot heat an object properly because of insufficient calorific power. Then, such a broken magnetron should be repaired or replaced to recover sufficient calorific power for the cooking device. Therefore, there is another concern that the cooking device cannot cook an object properly and respond to a demand for cooking, during the repair or replace.

The present invention was made in view of such a circumstance, and has a primary object to provide a cooking device in which a first electromagnetic generating unit and a second electromagnetic generating unit are spaced apart in an up-and-down direction and a first blowing path and a second blowing path for guiding air, which are flown by fans, around the respective electromagnetic generating units are provided, so as to allow equalization of two cooling effects on the two electromagnetic generating units, and enhancement of durability of the respective electromagnetic generating units.

A cooking device according to a first aspect of the present invention comprises: a first electromagnetic generating unit and a second electromagnetic generating unit that generate electromagnetic waves for cooking; a heating chamber that introduces the electromagnetic waves generated by the first and the second electromagnetic generating units, to heat an object; fans that cool the first and the second electromagnetic generating units, respectively; and a first blowing path and a second blowing path that guide respective air flown by the fans around the first and the second electromagnetic generating units, respectively wherein the first electromagnetic generating unit is arranged in an upper position and the second electromagnetic generating unit is arranged in a lower position.

In the cooking device according to the first aspect, a distance between the first and the second electromagnetic generating units can be made relatively long, while the first and the second electromagnetic generating units are arranged above and below of the cooking device. Therefore, the cooking device has an advantage to reduce an influence of “heat of air” that has cooled one of the two electromagnetic generating units on the other electromagnetic generating unit. Furthermore, in the cooking device, air blown through the first and the second blowing paths can cool the first and the second electromagnetic generating units, respectively and equally. Therefore, it is possible to equalize two cooling effects on the two electromagnetic generating units. Thus, the cooking device has an advantage to enhance durability of the respective electromagnetic generating units.

A cooking device according to a second aspect of the present invention is a cooking device wherein each of the first and the second electromagnetic generating unit comprises: an electromagnetic generating section; and a driving section that drives the electromagnetic generating section, and the driving sections of the first and the second electromagnetic generating units are opposed to each other, in an up-and-down direction.

In the cooking device according to the second aspect, a distance between the electromagnetic generating sections of the first and the second electromagnetic generating units can be made further longer, while the first and the second electromagnetic generating units are arranged above and below of the cooking device. Therefore, the cooking device has an advantage to reduce an influence of “heat of air” that has cooled one of the two electromagnetic generating units on the other electromagnetic generating unit, more significantly. Furthermore, in the cooking device, air blown through the first and the second blowing paths can cool the first and the second electromagnetic generating units, respectively and more equally. Therefore, the cooking device has an advantage to equalize two cooling effects on the two electromagnetic generating units, more preferably.

A cooking device according to a third aspect of the present invention further comprises: a ventilation duct that surrounds both lateral peripheries of the first and the second electromagnetic generating units; and a partition wall that vertically divides an inside of the ventilation duct into a portion for the driving section and a portion for the electromagnetic generating section of each of the first and the second electromagnetic wave generating unit.

In the cooking device according to the third aspect, it is possible to blow air intensively to the electromagnetic generating sections, while the electromagnetic generating sections generally become higher temperatures than the driving sections. Therefore, the cooking device has an advantage to cool intensively the each of the electromagnetic generating sections, which leads further preferable equalization of two cooling effects on the two electromagnetic generating units.

A cooking device according to a fourth aspect of the present invention is a cooking device wherein the partition wall comprises: a first partition plate that extends in an up-and-down direction on both lateral sides of the driving sections of both the first and the second electromagnetic generating units; and a second partition plate that extends laterally from the first partition plate.

In the cooking device according to the fourth aspect, it is possible to form the first partition plate and second partition plate in one ventilation duct. Therefore, the cooking device has an advantage to improve efficiency of maintenance actions, because a first blowing path and a second blowing path can be provided by incorporating the ventilation duct.

A cooking device according to a fifth aspect of the present invention further comprises: an insulating plate that extends in an up-and-down direction on a lateral side of the driving sections of both the first and the second electromagnetic generating units, wherein the insulating plate has an insertion hole; and a power supply line that is connected to the driving sections of both the first and the second electromagnetic generating units, through the insertion hole.

The cooking device according to the fifth aspect has an advantage to prevent electric leak from the power supply line to the ventilation duct side.

A cooking device according to a sixth aspect of the present invention is a cooking device wherein the insulating plate forms a part of the ventilation duct.

The cooking device according to the sixth aspect has an advantage to simplify a configuration around the ventilation duct because of a part of the ventilation duct having the insulating plate, which leads to improve an assembly operation more preferably.

A cooking device according to a seventh aspect of the present invention is a cooking device wherein each of the driving section comprises a power supply terminal that is protruding laterally, the ventilation duct comprises: an air regulating plate that is arranged on both lateral sides of the electromagnetic generating sections of both the first and the second electromagnetic generating units, wherein the air regulating plate has an aperture area that is arranged correspondingly to an arrangement of the power supply terminals, the insulating plate is superimposed on the air regulating plate, and the insertion hole is opened laterally on the basis of a position of the power supply terminal.

In the cooking device according to the seventh aspect, it is possible to mount and demount the insulating plate without demounting the power supply line connected to a power supply terminal, which keeps the insulating plate being mounted without tension and stress. Therefore, the cooking device has an advantage to make it possible to utilize an insulating plate with excellent electrical and thermal resistance despite it's inherent heavy mechanically fragility. Furthermore, the cooking device has an advantage to facilitate efficient mounting of the insulating plate.

A cooking device according to an eighth aspect of the present invention is a cooking device wherein the power supply line comprises: a connector that is connected to the power supply terminal and arranged inside the insertion hole, and the insulating plate is fixed to the connector by a blocking member that blocks off a gap between the insertion hole and the connector.

In the cooking device according to the eighth aspect, it is possible to fix the insulating plate by the blocking member. Therefore, the cooking device has an advantage to prevent accidental displacement of the insulating plate due to vibration or the like. Thus, the cooking device has an advantage to improve cooling properties of the electromagnetic generating unit.

A cooking device according to a ninth aspect of the present invention is a cooking device wherein the insulating plate is supported by insertion into a gap between the second partition plate and the air regulating plate.

In the cooking device according to the ninth aspect, it is possible to insert the insulating plate for support into a gap between the second partition plate and the air regulating plate. Furthermore, it is possible to pull out the insulating plate from the gap between the second partition plate and the air regulating plate. Therefore, the cooking device has an advantage to improve maintenance actions, because of facilitating to mount/demount the insulating plate when mounting/demounting the electromagnetic generating unit for maintenance.

A cooking device according to a tenth aspect of the present invention is a cooking device wherein the second partition plate is spaced apart vertically and laterally from an edge of the aperture area.

In the cooking device according to the tenth aspect, it is possible to insert the insulating plate inside of the regulating plate through a gap between the second partition plate and the edge of the aperture area, even though lateral distance between the second partition plate and one air regulating plate is different from lateral distance between the second partition plate and another air regulating plate, by transforming the insulating plate which is arranged on a shorter-lateral distance side. Therefore, the cooking device has an advantage to enhance operability for mounting the insulating plate.

The above and further objects and features of the invention will more fully be apparent from the following detailed description with accompanying drawings.

### BRIEF DESCRIPTION OF THE DRAWINGS

FIG. 1 is a schematic perspective view showing a configuration of a cooking device according to the present invention;

FIG. 2 is a partially omitted rear-side perspective view showing the configuration of the cooking device according to the present invention;

FIG. 3 is a partially omitted rear-side perspective view showing the configuration of the cooking device according to the present invention;

FIG. 4 is a front view showing the configuration of the cooking device according to the present invention;

FIG. 5 is a partially omitted plan view showing the configuration of the cooking device according to the present invention;

FIG. 6 is a partially omitted rear view showing the configuration of the cooking device according to the present invention;

FIG. 7 is a partially omitted right-side view showing the configuration of the cooking device according to the present invention;

FIG. 8 is a partially omitted left-side view showing the configuration of the cooking device according to the present invention;

FIG. 9 is a schematic sectional view showing the configuration of the cooking device according to the present invention;

FIG. 10A is a schematic front view showing a configuration of an electromagnetic generating unit, and FIG. 10B is a schematic side view thereof;

FIG. 11 is a schematic rear view showing a configuration for cooling a first electromagnetic generating unit and a second electromagnetic generating unit;

FIG. 12 is a schematic right-side view showing the configuration for cooling the first and the second electromagnetic generating units;

FIG. 13 is a schematic left-side view showing the configuration for cooling the first and the second electromagnetic generating units;

FIG. 14 is a sectional view of line X-X of FIG. 12;

FIG. 15A is an exploded side view showing a relation among the first electromagnetic generating unit, an air regulating plate and an insulating plate, FIG. 15B is a side view with the air regulating plate in a mounted state, and FIG. 15C is a side view with the air regulating plate and the insulating plate in a mounted state;

FIG. 16A is an exploded side view showing a relation among the second electromagnetic generating unit, the air regulating plate and the insulating plate, FIG. 16B is a side view with the air regulating plate in a mounted state, and FIG. 16C is a side view with the air regulating plate and the insulating plate in a mounted state;

FIG. 17 is a schematic rear view of the cooking device according to the present invention;

FIG. 18 is an explanatory view showing a relation between the first electromagnetic generating unit and an ventilation duct; and

FIG. 19 is an explanatory view showing the relation between the first electromagnetic generating unit and the ventilation duct.

### DESCRIPTION OF THE PREFERRED EMBODIMENT

In the following, the present invention is detailed based upon drawings showing embodiment thereof.

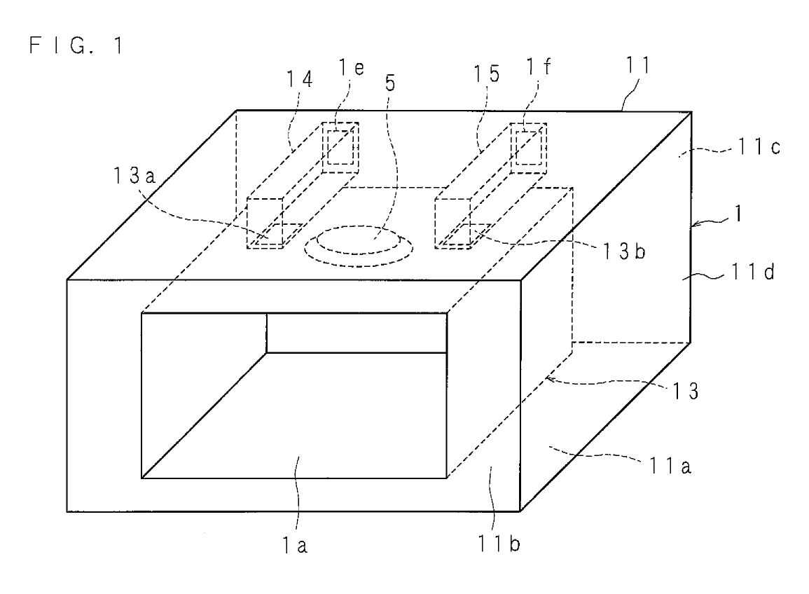

FIG. 1 is a schematic perspective view showing a configuration of a cooking device according to the present invention;

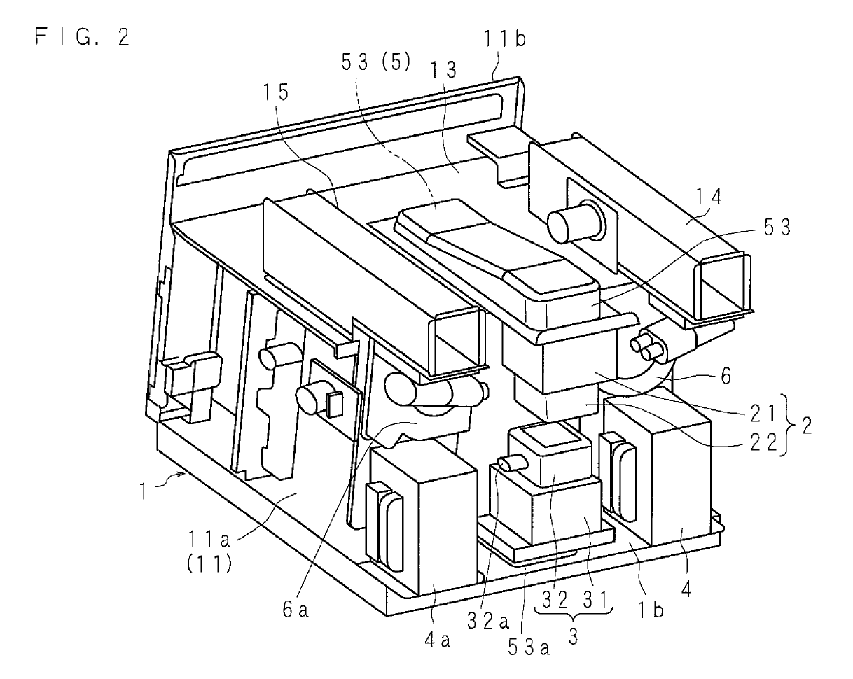

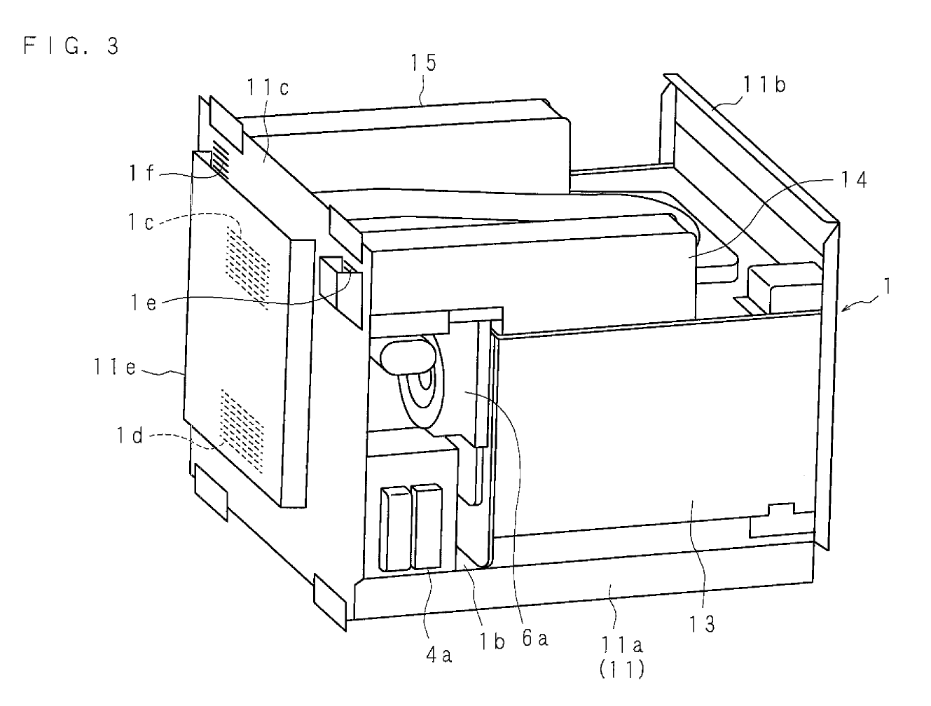

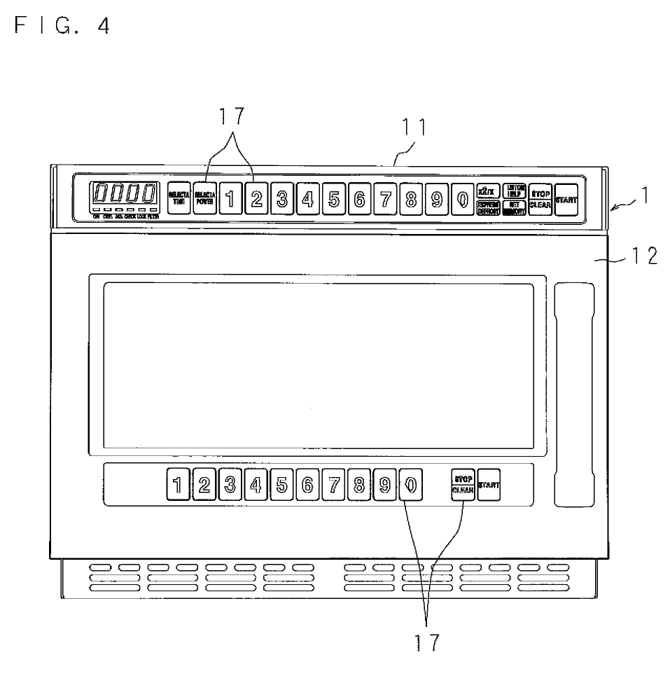

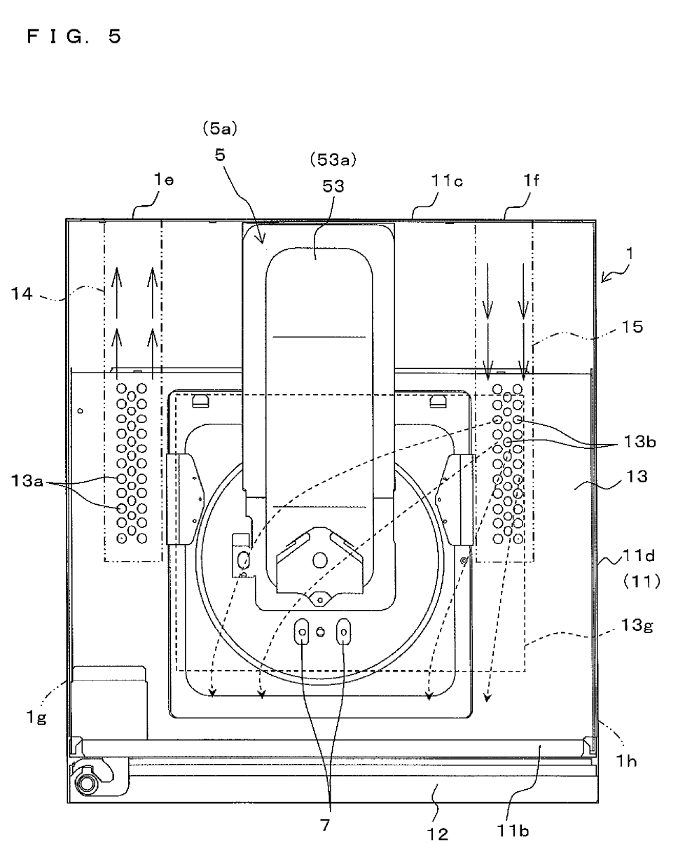

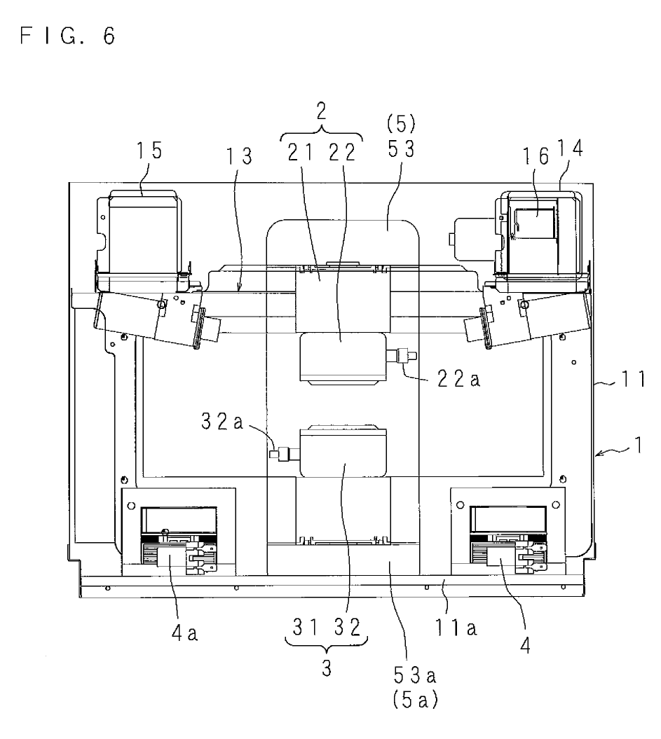

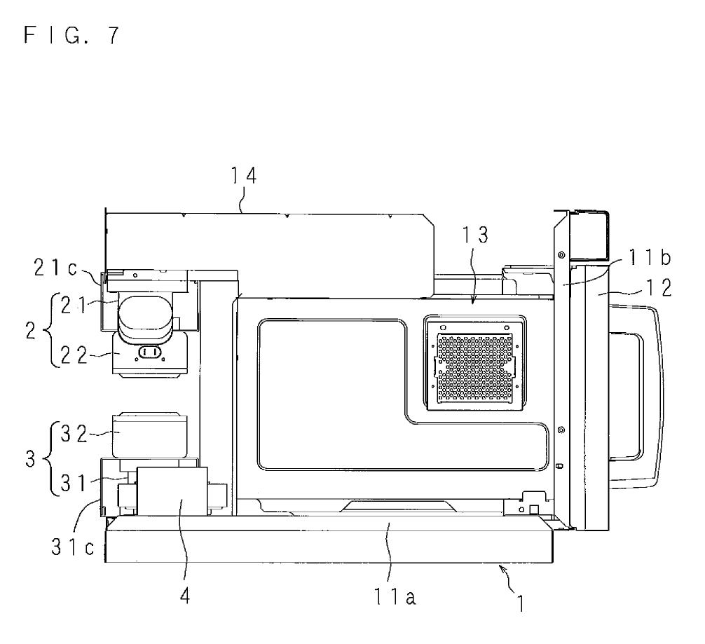

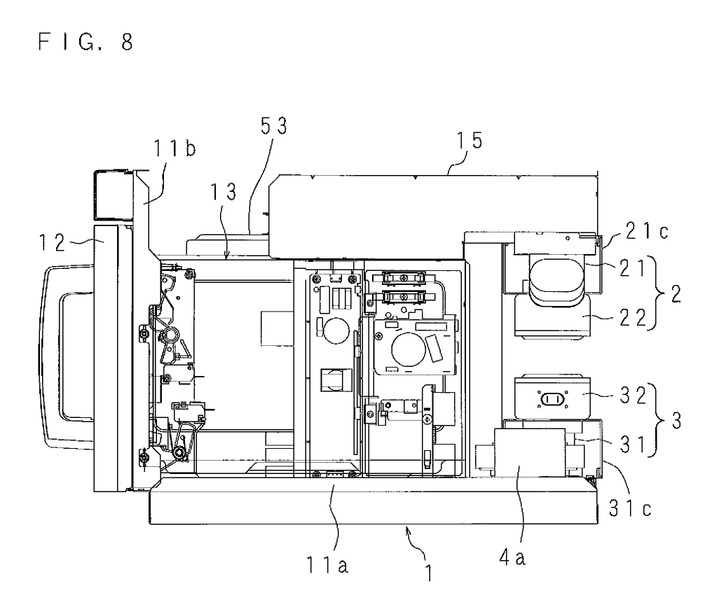

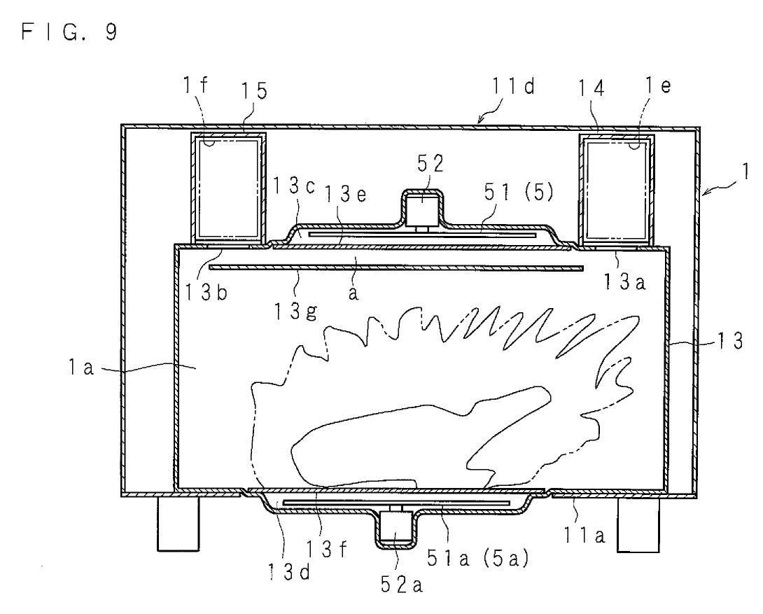

FIGS. 2 and 3 are partially omitted rear-side perspective views each showing the configuration of the cooking device; FIG. 4 is a front view showing the configuration of the cooking device; FIG. 5 is a partially omitted plan view showing the configuration of the cooking device; FIG. 6 is a partially omitted rear view showing the configuration of the cooking device; FIG. 7 is a partially omitted right-side view showing the configuration of the cooking device; FIG. 8 is a partially omitted left-side view showing the configuration of the cooking device; and FIG. 9 is a schematic sectional view showing the configuration of the cooking device.

The cooking device shown in FIG. 1 is a microwave oven that heats an object with electromagnetic waves. The cooking device has a heating chamber 1a on a front side for heating the object, and an electric equipment chamber 1b behind the heating chamber 1a. The cooking device includes: a cooking device body 1 that is formed in a substantial rectangular solid; a first and a second electromagnetic generating units 2, 3 housed in the electric equipment chamber 1b; transformers 4, 4a that drive the respective electromagnetic generating units 2, 3; a first and a second electromagnetic supplying units 5, 5a that guide the electromagnetic waves generated by the electromagnetic generating units 2, 3 to the heating chamber 1a, respectively; and a first and a second fans 6, 6a that cool the electromagnetic generating units 2, 3, respectively.

The cooking device body 1 is formed in a substantially rectangular solid shape, and includes: a cabinet 11 that has an open section at the front side of the heating chamber 1a; a door 12 that opens and closes the forward open section; a enclosure 13 that is anteriorly arranged in the cabinet 11 and has the heating chamber 1a; an exhaust duct 14 that is arranged above (or on) the enclosure 13 and guides air inside the heating chamber 1a to an outside of the cabinet 11; an intake duct 15 that is arranged above (or on) the enclosure 13 and supplies the outside air to the heating chamber 1a; a third fan 16 for discharging the air inside the heating chamber 1a into the exhaust duct 14; a control unit that controls electric components such as the electromagnetic generating units 2, 3; an operating section 17 that operates the control unit; and the like.

The cabinet 11 includes a base 11a that is formed in a rectangular shape; a front frame 11b that is connected to a front edge of the base 11a and has the open section; a rear frame 11c that is fixed at a rear edge of the base 11a; and a covering member 11d that has both-side plates and a top plate and is formed in a substantial reversal U-shape. The enclosure 13 is mounted on a front side of the base 11a. The door 12 is pivotably supported at one side of the open section of the front frame 11b.

The rear frame 11c includes grille-shaped first and second exhaust ports 1c, 1d that are vertically arranged an upper-center portion and a lower-center portion of the rear frame 11c; a grille-shaped third discharge port 1e that is arranged on one side of the upper portion of the rear frame 11e, and communicates to an outlet-side end of the exhaust duct 14; and a grille-shaped third intake port 1f that is arranged on the other side of the upper portion of the rear frame 11c, and communicates to an inlet-side end of an intake duct 15. Further, attached to the rear frame 11c is an exhaust guide plate 11e that is arranged correspondingly to a position opposed to the exhaust ports 1c, 1d of the rear frame 11c (cf. FIG. 3).

The covering member 11d provides grille-shaped first and second exhaust ports 1g, 1h at front portions of the both lateral sides (of FIG. 5).

The enclosure 13 is formed in a substantial rectangular solid having an open section at front side, and provides a discharge port 13a at one side of the top and a supply port 13b at the other side of the top. The enclosure 13 provides a circular recess 13c at the center of the top and a circular recess 13d at the center of the bottom. The recesses 13c, 13d interiorly provide rotational antennas 51, 51a having radial convexes and motors 52, 52a that drive the rotational antennas 51, 51a, respectively. The enclosure 13 includes cover plates 13e, 13f that are located at top and bottom of the heating chamber 1a and block openings of the circular recess 13c, 13d. Furthermore, the enclosure 13 includes, at top of the heating chamber 1a, sensors 7, 7 that detect driving/stopping of the rotational antennas 51, 51a, and a shielding plate 13g for forming air course “a” between this plate 13g and the top.

The exhaust duct 14 and the intake duct 15 are formed in rectangular column shapes and have equal sizes, each other. At the bottom, the exhaust duct 14 provides an inlet that corresponds to the discharge port 13a. At the bottom, the intake duct 15 provides an outlet that corresponds to the supply port 13b. Further, the exhaust duct 14 interiorly provides a third fan 16.

As described above, in the cooking device 1 that is formed in a substantial rectangular solid shape, the first electromagnetic supplying units 5 is positioned at the lateral center above (or on) the heating chamber 1a, while the second electromagnetic supplying units 5a is positioned at the lateral center below (or under) the heating chamber 1a. The first electromagnetic generating unit 2 is positioned behind the heating chamber 1a at the upper lateral center in the cooking device 1, while the second electromagnetic generating unit 3 is positioned behind the heating chamber 1a at the lower lateral center in the cooking device 1. The first and second fans 6, 6a are positioned at the front portions of the both sides of the first electromagnetic generating unit 2, while the transformers 4, 4a are positioned on the both sides of the second electromagnetic generating unit 3.

The first and second electromagnetic supplying units 5, 5a are formed in a substantial oval bowl shape, and include: wave guides 53, 53a that are anteroposteriorly arranged; the rotational antennas 51, 51a; and the motors 52, 52a that drive the rotational antennas 51, 51a. The wave guide 53 has an open side that is opposed to the top of the heating chamber 1a, while the wave guide 53a has an open side that is opposed to the bottom of the heating chamber 1a. The longitudinal rear edges of the wave guides 53, 53a are behind the enclosure 13. The longitudinal front edges of the wave guides 53, 53a are around the anteroposterior center of the enclosure 13. Further, the wave guides 53, 53a serve as the above-mentioned recesses 13c, 13d.

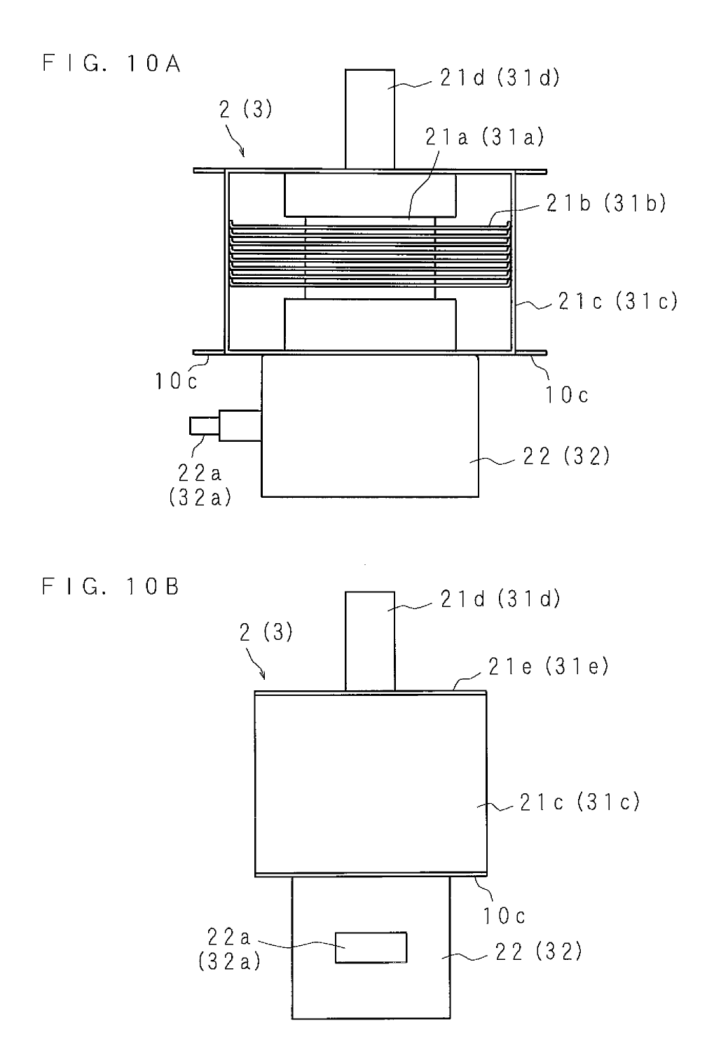

FIGS. 10A and 10B show configurations of the electromagnetic generating units 2, 3, where FIG. 10A is a schematic front view and FIG. 10B is a schematic side view. The first electromagnetic generating unit and the second electromagnetic generating unit 2, 3 consist of magnetrons that include electromagnetic generating sections 21, 31 for generating electromagnetic waves for cooking and driving sections 22, 32 that drive the electromagnetic generating sections 21, 31.

The electromagnetic generating sections 21, 31 provide: resonant sections 21a, 31a, each of which is formed in a substantial rectangular column profile and includes an anode and a cathode that is arranged concentrically with the anode; a plurality of fins 21b, 31b whose fins are arranged in parellel, each other, on outer peripheries of the resonant sections 21a, 31a; frame yokes 21c, 31c that partially cover the resonant sections 21a, 31a and the fins 21b, 31b; and the antennas 21d, 31d, each of which protrudes from one end of the resonant section 21a, 31a toward the outside of the frame yoke 21c, 31c and outputs microwave generated by the resonant section 21a, 31a. The other ends of the resonant sections 21a, 31a are connected with the driving sections 22, 32 having power supply circuits and power supply terminals 22a, 32a. The power supply terminals 22a, 32a are connected with the power supply circuits.

The frame yokes 21c, 31c are formed in rectangular hollow column shapes that are opened anteroposteriorly. The resonant sections 21a, 31a are fitted into holes between the opposing upper and under surfaces of the frame yokes 21c, 31c. Further, the frame yokes 21c, 31c provide mounting pieces, at the ends near the antennas 21d, 31d, in protruding conditions. Furthermore, the frame yokes 21c, 31c provide second partition plates 10c, 10c, at the ends near the driving-sections 22, 32, in laterally and outwardly extending conditions. Each of the second partition plates 10c, 10c is one end of a metal plate that is formed in a substantial L-shape. The metal plate has the other end that is fixed to both side surfaces of the frame yokes 21c or 31c by male screws.

The driving sections 22, 32 are formed in angular cylindrical shapes, and are arranged outside of the frame yokes 21c, 31c. Further, the driving sections 22, 32 are arranged above and below, and are opposed each other. Furthermore, the each of driving sections 22, 32 provides the power supply terminal 22a or 32a, at one side, in a extending condition. Each of the power supply terminals 22a, 32a is connected, through a connector 20a, with one end of the power supply line 20 whose the other end is connected with the transformer 4 or 4a.

In the electromagnetic generating units 2, 3 described above, the driving sections 22, 32 are arranged above and below, and are opposed each other. The electromagnetic generating section 21 is arranged on the driving section 22, while the electromagnetic generating section 31 is, on the other hand, arranged under the driving section 32. The power supply terminals 22a, 32a are arranged symmetrically in a lateral direction. The mounting piece of the frame yoke 21c is attached to the top plate of a ventilation duct, which is described later. The antenna 21d is arranged inside a rear portion of the wave guide 53. Further, the mounting piece of the frame yoke 31c is attached to the bottom plate of the ventilation duct, which is described later. The antenna 31d is arranged inside a rear portion of the wave guide 53a. Moreover, the frame yokes 21c, 31c are opened anteroposteriorly.

Therefore, the first and the second electromagnetic generating units 2, 3, which are arranged above and below behind the heating chamber 1a, are backwardly spaced from the heating chamber 1a. Further, on lateral peripheries of the electromagnetic generating units 2, 3, the ventilation duct 9 and partition wall 10 serve to form a first blowing path and a second blowing path 8, 8a which serve to blow almost equivalent amount of air for cooling to the respective electromagnetic generating units 2, 3.

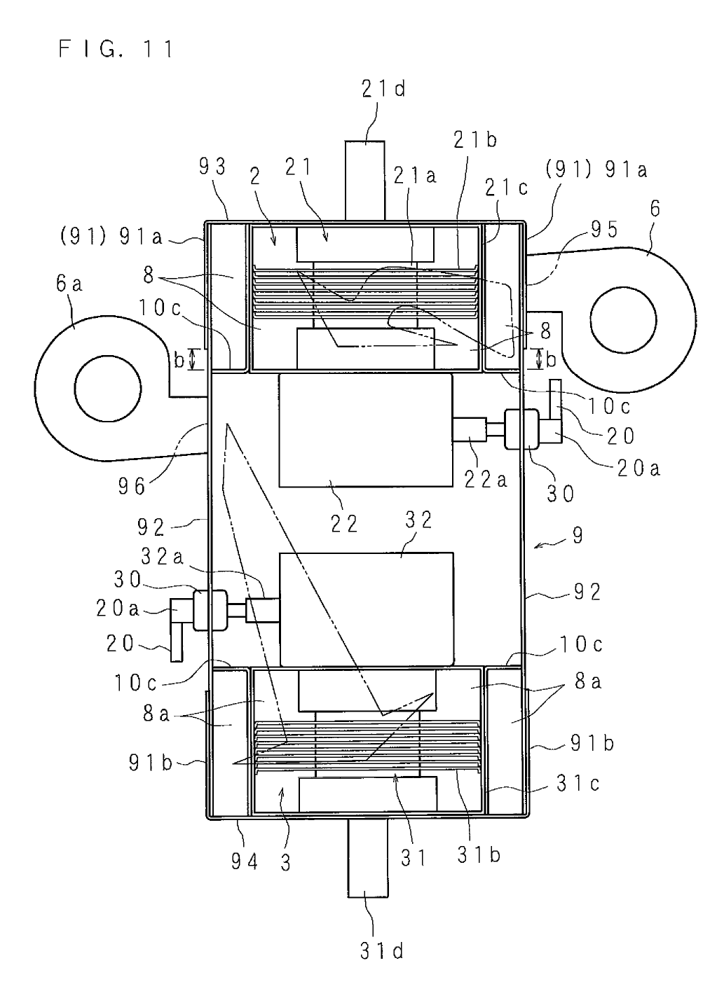

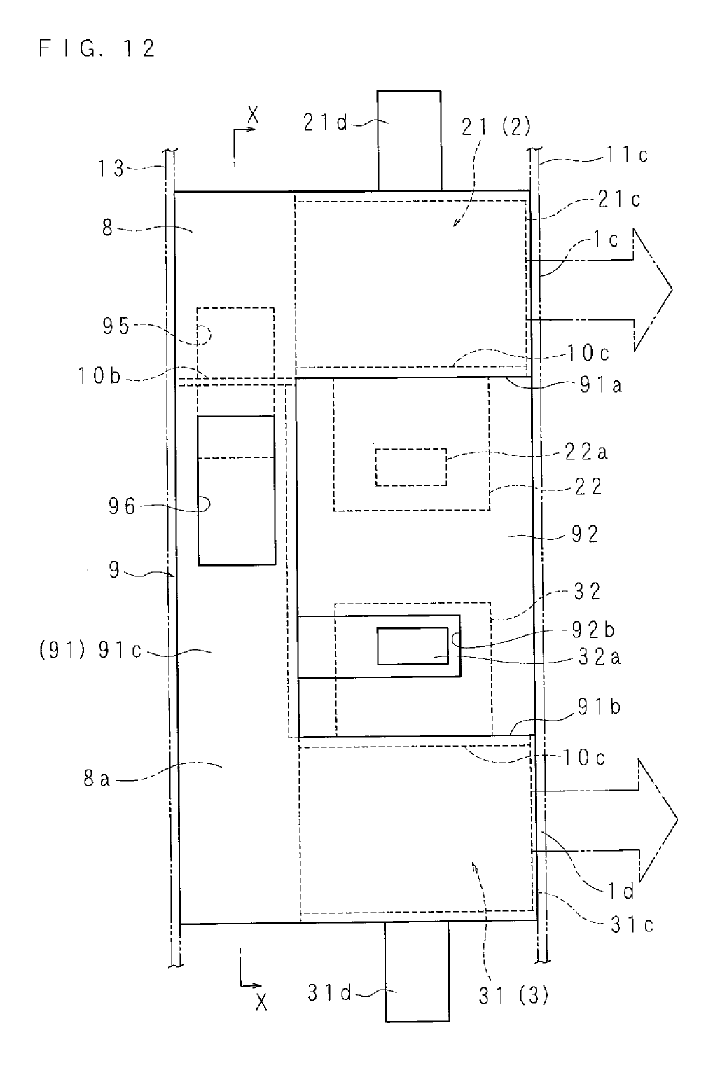

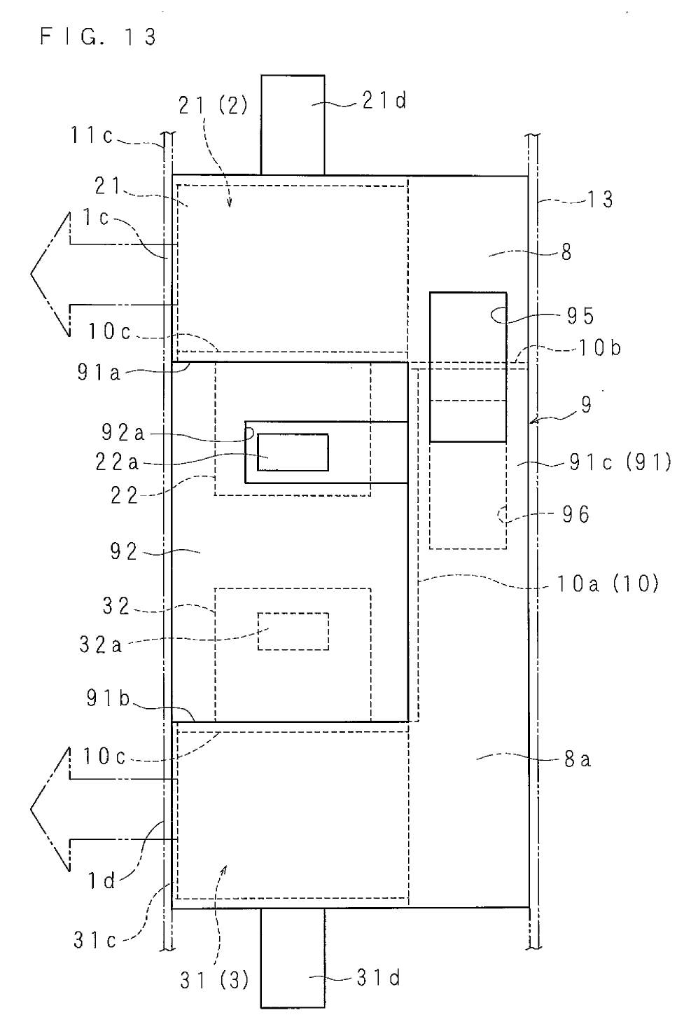

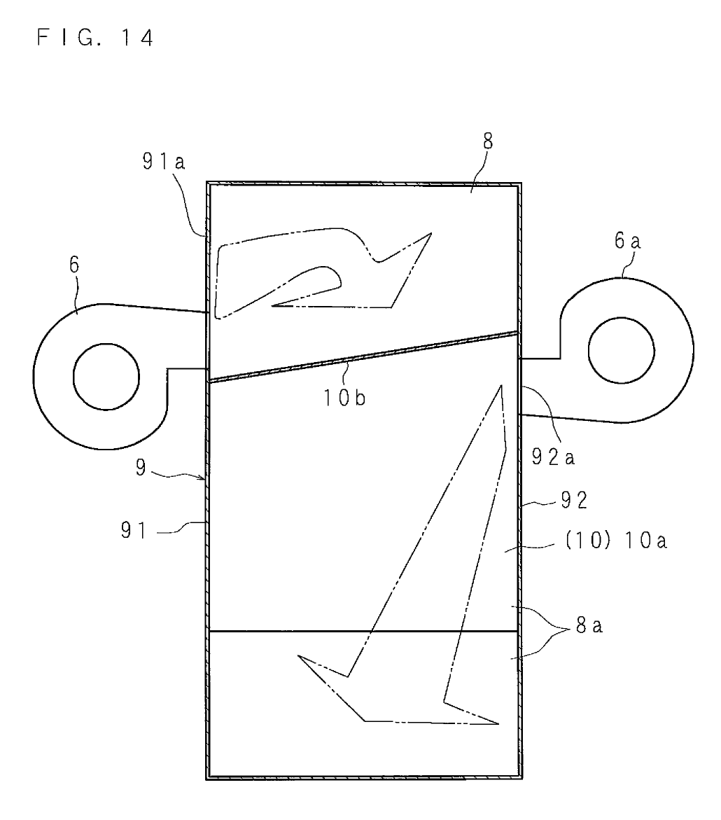

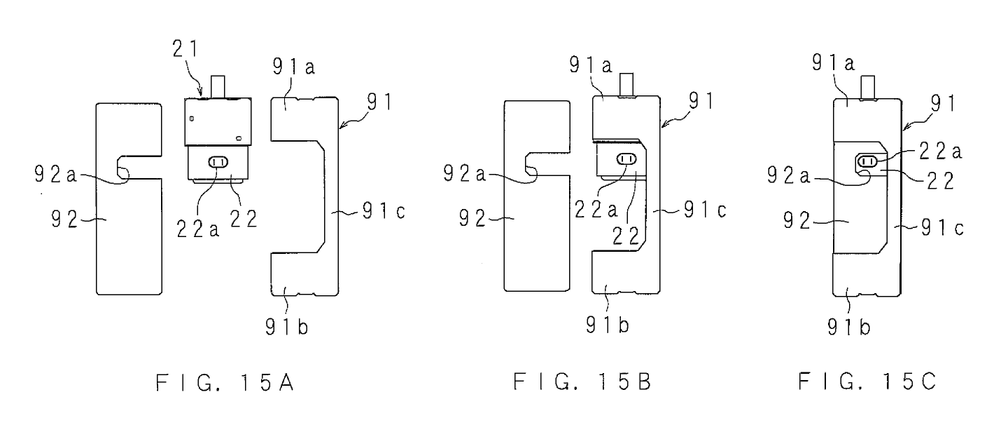

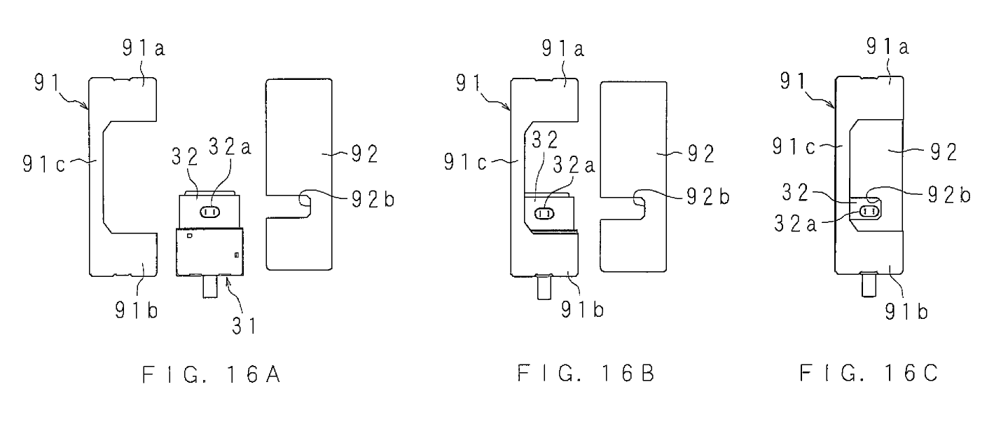

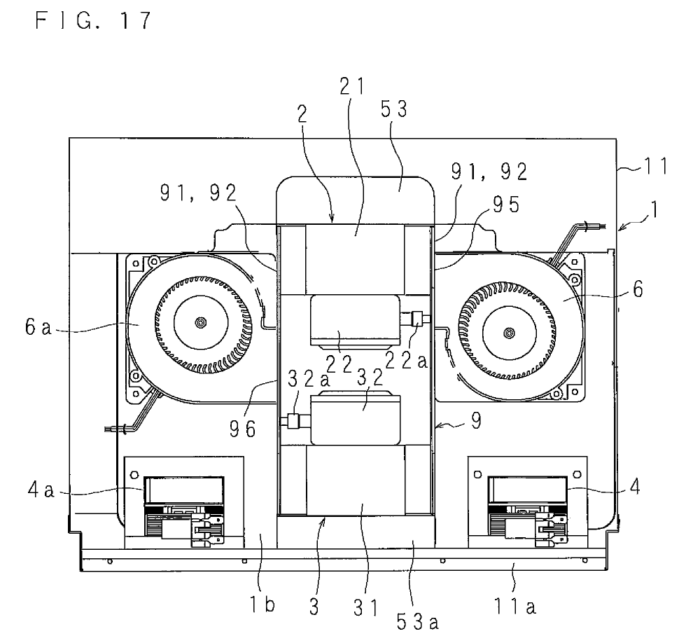

FIGS. 11 to 16C show configurations for cooling the first and the second electromagnetic generating units 2, 3. FIG. 11 is a schematic rear view, FIG. 12 is a schematic right-side view, FIG. 13 is a schematic left-side view, and FIG. 14 is a sectional view of line X-X of FIG. 12. FIGS. 11A, 15B, 15C each show a relation among the first electromagnetic generating unit, an air regulating plate and an insulating plate, where FIG. 15A is an exploded side view, FIG. 15B is a side view with the air regulating plate in a mounted state, and FIG. 150 is a side view with the air regulating plate and the insulating plate in a mounted state. Further, FIGS. 16A, 16B, 16C each show a relation among the second electromagnetic generating unit, the air regulating plate and the insulating plate, where FIG. 16A is an exploded side view, FIG. 16B is a side view with the air regulating plate in a mounted state, and FIG. 16C is a side view with the air regulating plate and the insulating plate in a mounted state. Moreover, FIG. 17 is a schematic rear view of the cooking device.

The ventilation duct 9 includes: two air regulating plates 91, 91 that are extending vertically and spaced laterally apart each other by arrangement on both sides of the first and the second electromagnetic generating units 2, 3; two insulating plates 92, 92 that are partially superimposed on part of the air regulating plates 91, 91; a rear surface of the enclosure 13; the rear frame 11c having the first and the second exhaust ports 1c, 1d; a top plate 93 fixed to an upper portion of the first electromagnetic generating section 21; and a bottom plate 94 fixed to a lower portion of the second electromagnetic generating section 21. The partition wall 10 is arranged in the ventilation duct 9 to divide the latter into top and bottom portions, for the driving-sections 22, 32 and magnetic generating-sections 21, 31. This configuration then forms the first and the second blowing path 8, 8a.

The air regulating plate 91 is a metal plate, and includes: a first and a second plate sections 91a, 91b that are arranged on the lateral sides of the electromagnetic generating sections 21, 31; and a connecting section 91c that is continued from front portions of the plate sections 91a, 91b. Further, the air regulating plate 91 is formed in a substantial U-shape that is opened at the portion corresponding to lateral sides of the driving sections 22, 32. A first inlet port 95 is opened at a portion near one side of the connecting section 91c of the first plate section 91a, while a second inlet port 96 is opened at a portion near the other side of the connecting section 91c. The first inlet port 95 communicates to an outlet port for the first fan 6, while the second inlet port 96 communicates to an outlet port for the second fan 6a.

As shown in FIG. 11, there are lateral separations “b” between the second partition plate 10c protruding from the frame yoke 21c and an under edge (opening edge) of the first plate section 91a, and between the second partition plate 10c protruding from the frame yoke 21c and an upper edge (opening edge) of the second plate section 91b. The lateral separations “b” are laterally spaced apart, each other.

The insulating plate 92 is a built-up mica that has an excellent processibility as well as heat resistance and voltage endurance. One insulating plate 92 has an insertion hole 92a that is backwardly recessed at the portion corresponding to the power supply terminal 22a, while another insulating plate 92 has an insertion hole 92b that is backwardly recessed at the portion corresponding to the power supply terminal 32a. An upper portion of the insulating plate 92 is supported by insertion into a gap between the first plate section 91a and the second partition plate 10b, while a lower portion of the insulating plate 92 is supported by insertion a gap between the second plate section 91b and the second partition plate 10b. Further, the insertion holes 92a, 92b interiorly provide the connectors 20a, 20a. It is to be noted that, the insulating plate 92 is possible to be mounted without external tension and stress because of being softly supported by insertion, although the built-up mica is generally known to be difficult for fixing with screwing and caulking and to be unsuitable for mounting on a structure material like a duct wall because of mechanical fragility.

A clearance between the insertion hole 92a and the connector 20a and a clearance between the insertion hole 92b and the connector 20a are blocked by blocking members 30, 30 that have insulating properties, and then blocking members 30, 30 fix the insulating plates 92, 92 to the connectors 20a, 20a.

The top plate 93 is formed integrally with the first plate sections 91a, 91a of the two air regulating plates 91, 91, while a front end of the top plate 93 is fixed to an upper portion of the enclosure 13. Further, the top plate 93 is attached to the frame yoke 21c, while having a penetrating hole at the center for insertion of the antenna 21d.

The bottom plate 94 is formed integrally with the second plate sections 91b, 91b of the two air regulating plates 91, 91, while a front end of the top plate 93 is fixed to a lower portion of the enclosure 13. Further, the bottom plate 94 is attached to the frame yoke 31c, while having a penetrating hole at the center for insertion of the antenna 31d.

The partition wall 10 consists of: a first partition plate 10a that is extending in an up-and-down direction between the electromagnetic generating sections 21, 31 and between the second inlet port 96 and the driving sections 22, 32, and divides centrally an inside of the ventilation duct 9 into a front portion and a back portion; and second partition plates 10b, 10c that are arranged laterally from the top end of the first partition plate 10a between the first and second inlet port 95, 96, and divide a former inside of the ventilation duct 9 near the inlet port 95, 96 (front side) into upper portions and lower portions. Further, the partition wall 10 serves to form the first blowing path 8 around the upper portion of the ventilation duct 9 and the second blowing path 8a around the lower portion of the ventilation duct 9. The second partition plate 10b is connected to the first plate sections 91a, 91a of the air regulating plates 91, 91, and is vertically inclined as shown in FIG. 14. In FIG. 14, one end of the second partition plate 10b near the first fan 6 is lower than the other end of the second partition plate 10b near the second fan 6a. The second partition plates 10c, 10c protrude at a lower portion of the frame yoke 21c and at an upper portion of the frame yoke 31c.

The first and the second blowing paths 8, 8a are set to blow substantial quivalent amount of air. The first blowing path 8 is formed between the first inlet port 95 and the first exhaust port 1c, inside the frame yoke 21c, while between the air regulating plates 91, 91 and the frame yoke 21c. Further, the first blowing path 8 communicates to the first exhaust port 1c. The second blowing path 8a is formed between the second inlet port 96 and the second exhaust port 1d, as well as between the first partition plate 10a and the rear surface of the enclosure 13, inside the frame yoke 31c, and between the air regulating plates 91, 91, the insulating plates 92, 92 and the frame yoke 31c. Further, the second blowing path 8a communicates to the second exhaust port 1d.

The first and the second fans 6, 6a are arranged at rear portions of the enclosure 13, while the first and second inlet ports 95, 96 are opposed to each other.

In the cooking device as described above, manipulation of the operating section 17 on the front surface allows the control unit to energize the driving sections 22, 32 of the electromagnetic generating units 2, 3 that are arranged above and below behind the heating chamber 1a. The antennas 21d, 31d of the electromagnetic generating sections 21, 31, then, output fluxes of electromagnetic wave into the wave guides 53, 53a. These fluxes of electromagnetic wave are introduced into the heating chamber 1a by the wave guides 53, 53a and the rotational antennas 51, 51a, to cook an object in the heating chamber 1a. During this procedure, the first to third fans 6, 6a, 16 are driven, too.

Air in the heating chamber 1a is sucked from the discharge port 13a of the enclosure 13 into the exhaust duct 14 by the third fan 16. Then, an inner pressure of the heating chamber 1a is decreased to suck external air from the third intake port 1f into the intake duct 15. The air sucked into the intake duct 15 is supplied to the heating chamber 1a through the supply port 13b. Then, air in the heating chamber 1a is passed inside the exhaust duct 14 and discharged from the third discharge port 1e to the outside.

Further, external air is sucked into the covering member 11d by the first and the second fans 6, 6a, from the first and the second exhaust ports 1g, 1h that are opened on the covering member 11d. The air blown out from the outlet port of the first fan 6 is guided to the first blowing path 8 through the first inlet port 95. Therefore, it is possible for the air guided to the first blowing path 8 to intensively cool the lateral periphery of the electromagnetic generating section 21. Furthermore, the air blown out from the outlet port of the second fan 6a is guided to the second blowing path 8a through the second inlet port 96. Therefore, it is possible for the air guided to the second blowing path 8a to intensively cool the lateral periphery of the electromagnetic generating section 31.

The air of the first blowing path 8 is discharged to the outside from the first exhaust port 1c of the rear frame 11c, while the air of the second blowing path 8a is discharged to the outside from the second exhaust port 1d of the rear frame 11c. It is possible to equalize the amounts of air supplied from the first and the second blowing paths 8, 8a to the lateral peripheries of the electromagnetic generating sections 21, 31. Therefore, the cooking device has an advantage to substantially equalize cooling effects on the electromagnetic generating sections 21, 31. Furthermore, in the cooking device, all air blown out by the fans 6, 6a are supplied to the lateral peripheries of the electromagnetic generating sections 21, 31, while the partition wall 10 blocks air flows to and from the driving sections 22, 32 that generate a relatively small quantity of heat. Therefore, it is possible to enhance the cooling effects on the electromagnetic generating sections 21, 31. Thus, the cooking device has an advantage to enhance durability of the electromagnetic generating units 2, 3 by prevention of overheating the electromagnetic generating sections 21, 31 even in a case of operation with extended period for business use.

As described above, the cooking device provides the ventilation duct 9, solid metal plates to support the electromagnetic generating units 2, 3 and the insulating plates 92, 92 that are free from tension and stress. Therefore, the cooking device can allow the full utilization of forced draft cooling system for the electromagnetic generating units 2, 3. Further, the insulating plates 92, 92 partially forming the ventilation duct 9 are softly supported by insertion at the upper and the lower portions, and blocked off the clearance between the connectors 20a, 20a of the power supply lines 20, 20 connected to the power supply terminals 22a, 32a and the insertion holes 92a, 92b by the blocking members, 30, 30 having plasticity. Therefore, the insulating plates 92, 92 can be demounted without particular use of tools, even when demounting the electromagnetic generating units 2, 3 for maintenance. Thus, the cooking device has an advantage to improve efficiency of maintenance actions. Furthermore, the cooking device has an advantage to improve reliability of the ventilation duct 9 portion, because these configurations prevent wastage/damage of a screw head/thread and the like that are concerned for screw-fixed insulating plates.

Moreover, as shown in FIG. 11, the lower edge of the first plate section 91a is spaced vertical “b” apart from the second partition plate 10c, while the upper edge of the second plate section 91b is spaced vertical “b” apart from the second partition plate 10c. Therefore, it is possible to facilitate mounting/demount of the insulating plates 92, 92 for maintenance. Thus, the cooking device has an advantage to improve efficiency of maintenance actions further.

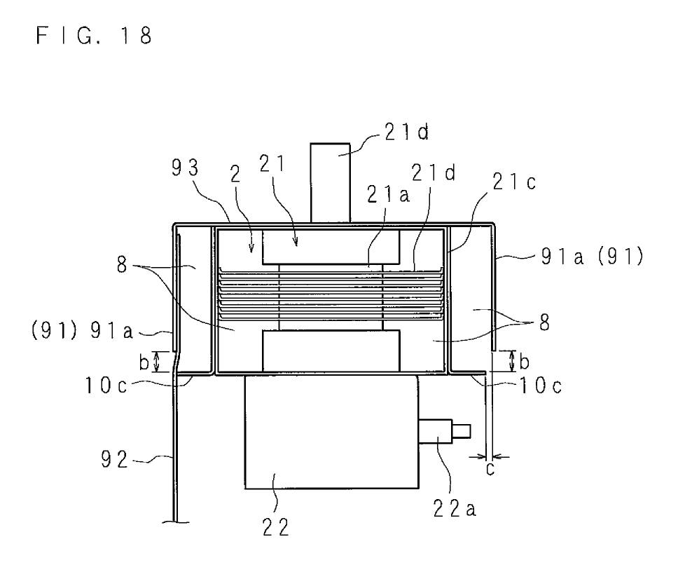

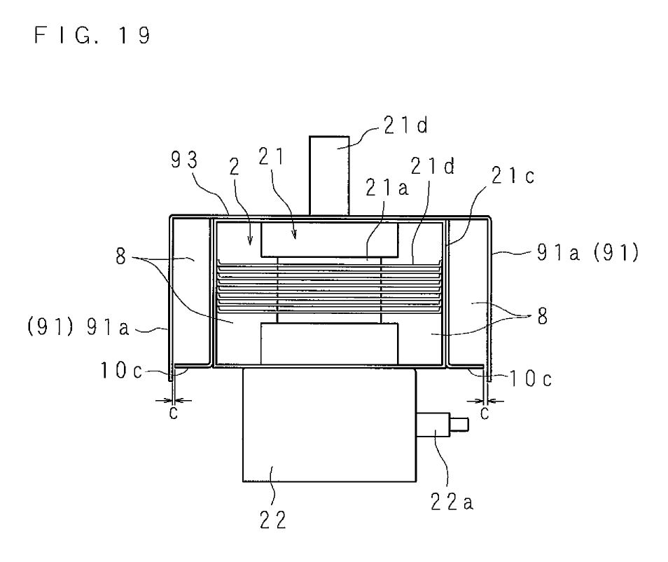

FIGS. 18 and 19 are explanatory views that show relations between the first electromagnetic generating unit 2 and the ventilation duct 9. As shown in FIG. 11, the embodiment described above provides the vertical separations “b” and the lateral separations “c” between the lower edge of the first plate section 91a and the second partition plate 10c, and between the upper edge of the second plate section 91b and the second partition plate 10c. Therefore, even in a case where distances of the lateral separations “c” between the second partition plates 10c, 10c and the two air regulating plates 91, 91 are different from each other, it is possible to insert the insulating plate 92 inside the first plate section 91a through a gap under the lower edge of the first plate section 91a by bending the insulating plate 92 having plastic property that is arranged near the shorter separation “c” as shown in FIG. 18. It is to be noted that, in a cooking device that provides the second partition plates 10c, 10c opposing to the air regulating plates 91, 91 without vertical separations “b” between the lower edge of the first plate section 91a and the second partition plate 10c as shown in FIG. 19, it is difficult to insert the insulating plate 92 near the shorter separation “c” into a gap between the first plate section 91a and the second partition plate 10c.

In addition, although the embodiment described above is configured to have the two fans 6, 6a that supply air to the first and the second blowing paths 8, 8a, another embodiment may have one fan that supplies air to both the first and the second blowing paths 8, 8a. Further, although the embodiment described above is configured to have the first and the second blowing paths 8, 8a that supply air to the lateral peripheries of the electromagnetic generating sections 21, 31, another embodiment may have the first and the second blowing paths 8, 8a that supply air to the peripheries of the electromagnetic generating sections 21, 31 and the driving sections 22, 32, individually.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. A cooking device, comprising:
a first electromagnetic generating unit and a second electromagnetic generating unit that generate electromagnetic waves for cooking;
a heating chamber that introduces the electromagnetic waves generated by the first and the second electromagnetic generating units, to heat an object;
fans that cool the first and the second electromagnetic generating units, respectively; and
a first blowing path and a second blowing path that guide respective air flown by the fans around the first and the second electromagnetic generating units, respectively,
wherein the first electromagnetic generating unit is arranged in an upper position and the second electromagnetic generating unit is arranged in a lower position.

2. The cooking device according to claim 1, wherein
each of the first and the second electromagnetic generating unit comprises:
an electromagnetic generating section; and
a driving section that drives the electromagnetic generating section, and
the driving sections of the first and the second electromagnetic generating units are opposed each other, in an up-and-down direction.

3. The cooking device according to claim 2, further comprising:
a ventilation duct that surrounds both lateral peripheries of the first and the second electromagnetic generating units; and
a partition wall that vertically divides an inside of the ventilation duct into a portion for the driving section and a portion for the electromagnetic generating section of each of the first and the second electromagnetic wave generating unit.

4. The cooking device according to claim 2, further comprising:
an insulating plate that extends in an up-and-down direction on a lateral side of the driving sections of both the first and the second electromagnetic generating units, wherein the insulating plate has an insertion hole; and
a power supply line that is connected to the driving sections of both the first and the second electromagnetic generating units, through the insertion hole.

5. The cooking device according to claim 3, wherein
the partition wall comprises:
a first partition plate that extends in an up-and-down direction on the both lateral sides of the driving sections of both the first and the second electromagnetic generating units; and
a second partition plate that extends laterally from the first partition plate.

6. The cooking device according to claim 3, further comprising:
an insulating plate that extends in an up-and-down direction on a lateral side of the driving sections of both the first and the second electromagnetic generating units, wherein the insulating plate has an insertion hole; and
a power supply line that is connected to the driving sections of both the first and the second electromagnetic generating units, through the insertion hole.

7. The cooking device according to claim 4, wherein
the insulating plate forms a part of the ventilation duct.

8. The cooking device according to claim 5, further comprising:
an insulating plate that extends in an up-and-down direction on a lateral side of the driving sections of both the first and the second electromagnetic generating units, wherein the insulating plate has an insertion hole; and
a power supply line that is connected to the driving sections of both the first and the second electromagnetic generating units, through the insertion hole.

9. The cooking device according to claim 6, wherein the insulating plate forms a part of the ventilation duct.

10. The cooking device according to claim 7, wherein
each of the driving section comprises a power supply terminal that is protruding laterally
the ventilation duct comprises:
an air regulating plate that is arranged on both lateral sides of the electromagnetic generating sections of both the first and the second electromagnetic generating units, wherein the air regulating plate has an aperture area that is arranged correspondingly to an arrangement of the power supply terminals,
the insulating plate is superimposed on the air regulating plate, and
the insertion hole is opened laterally on the basis of a position of the power supply terminal.

11. The cooking device according to claim 8, wherein
the insulating plate forms a part of the ventilation duct.

12. The cooking device according to claim 9, wherein
each of the driving section comprises a power supply terminal that is protruding laterally,
the ventilation duct comprises:
an air regulating plate that is arranged on both lateral sides of the electromagnetic generating sections of both the first and the second electromagnetic generating units, wherein the air regulating plate has an aperture area that is arranged correspondingly to an arrangement of the power supply terminals,
the insulating plate is superimposed on the air regulating plate, and
the insertion hole is opened laterally on the basis of a position of the power supply terminal.

13. The cooking device according to claim 10, wherein
the insulating plate is supported by insertion into a gap between the second partition plate and the air regulating plate.

14. The cooking device according to claim 10, wherein
the power supply line comprises:
a connector that is connected to the power supply terminal and arranged inside the insertion hole, and
the insulating plate is fixed to the connector by a blocking member that blocks off a gap between the insertion hole and the connector.

15. The cooking device according to claim 11, wherein
each of the driving section comprises a power supply terminal that is protruding laterally,
the ventilation duct comprises:
an air regulating plate that is arranged on both lateral sides of the electromagnetic generating sections of both the first and the second electromagnetic generating units, wherein the air regulating plate has an aperture area that is arranged correspondingly to an arrangement of the power supply terminals,
the insulating plate is superimposed on the air regulating plate, and
the insertion hole is opened laterally on the basis of a position of the power supply terminal.

16. The cooking device according to claim 12, wherein
the power supply line comprises:
a connector that is connected to the power supply terminal and arranged inside the insertion hole, and
the insulating plate is fixed to the connector by a blocking member that blocks off a gap between the insertion hole and the connector.

17. The cooking device according to claim 12, wherein
the insulating plate is supported by insertion into a gap between the second partition plate and the air regulating plate.

18. The cooking device according to claim 13, wherein
the second partition plate is spaced apart vertically and laterally from an edge of the aperture area.

19. The cooking device according to claim 15, wherein
the power supply line comprises:
a connector that is connected to the power supply terminal and arranged inside the insertion hole, and
the insulating plate is fixed to the connector by a blocking member that blocks off a gap between the insertion hole and the connector.

20. The cooking device according to claim 17, wherein
the second partition plate is spaced apart vertically and laterally from an edge of the aperture area.
